(19) United States
(12) Patent Application Publication
(10) Pub. No.: US 2025/0307738 A1
(43) Pub. Date: Oct. 2, 2025

(54) SYSTEM FOR AUTOMATICALLY GENERATING CHILD ISSUES FROM A PARENT ISSUE USING A GENERATIVE ENGINE

(71) Applicant: Atlassian Pty Ltd., Sydney (AU)

(72) Inventors: Harrison Dempsey, Sydney (AU); Marcus Peterson, Sydney (AU); Terry Agapitos, Sydney (AU)

(21) Appl. No.: 18/622,767

(22) Filed: Mar. 29, 2024

(51) Int. Cl. G06Q 10/0631

(52) U.S. Cl. CPC G06Q 10/06313

(57) ABSTRACT

Systems and methods described herein are configured to generate a set of child issues based on a parent issue. A system may be configured to obtain information from the parent issue and get resource identifiers to traverse a content node graph. The content node graph may provide other resource identifiers related to the initial resource identifier, which can, in turn, be used to fetch content from the system. The content is used to provide context beyond the parent issue. The parent issue, the context, and other predetermined formats and queries are used to generate a prompt that is submitted to a generative output engine. Based on the output from the generative engine, the system decides if more context is needed and/or extracts suggested subtasks from the output. The suggested subtasks may be used to cause child issues to be generated in the issue tracking platform.

### TECHNICAL FIELD

Embodiments described herein relate to issue tracking systems and, in particular, to systems that leverage large language models to generate child issues from a parent issue within the issue tracking system.

### BACKGROUND

Generalized projects or a tasks generally outline goals and requirements to reach those goals. However, often these tasks do not provide enough guidance to complete them and thus may be broken up in individualized, more specific tasks that can be delegated. However, due to the diverse multiplatform environments that enterprises operate in, it is hard to find all the resources to effectively leverage past work. For example, teams often use a wide variety of software platforms, such as content collaboration platforms, issue tracking platforms, project management platforms, software development platforms, and the like, to effectively perform their work. As the content within each of these software platforms grow, creating useful tasks that leverage this content becomes increasingly difficult.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified diagram of a system, such as described herein that can generate subtasks using a generative output engine.

FIG. 2A-2C depict an example user interface of an issue tracking platform that displays parent issues and generated subtasks.

FIG. 3 depicts an example content node graph.

FIG. 4 depicts a simplified diagram for traversing the content node graph.

FIG. 5 depicts a simplified system diagram of a system of generating subtasks.

FIG. 6 depicts an example method for generating subtasks.

FIG. 7A depicts a simplified diagram of a system that can include and/or may receive input from a generative output engine.

FIG. 7B depicts a functional system diagram of a system that can be used to implement a multiplatform prompt management service.

FIG. 8A depicts a simplified system diagram and data processing pipeline.

FIG. 8B depicts a system providing multiplatform prompt management as a service.

FIG. 9 depicts an example use of a generative output engine with a content collaboration platform.

FIG. 10 depicts an example directory platform having a graphical user interface including a home page for an entry.

FIG. 11 depicts a sample electrical block diagram of an electronic device that may perform the operations described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### SUMMARY

Embodiments described herein relate to a method for generating a set of child issues based on a parent issue. The method may include: display of the parent issue in a graphical user interface of an issue tracking system may be caused. In response to a user input provided to the graphical user interface, the user input including a request for a set of subtasks based on the parent issue, a resource identifier may be identified using content extracted from the parent issue. A first node of a content graph may be accessed using the resource identifier. A first set of nodes having an edge with the first node in the content graph may be identified. A prompt may be generated including a predefined query prompt text including a request to rank nodes and a completion criterion, and content extracted from the first set of nodes. The prompt may be provided to an external generative output engine using an application programming interface call. A generative response from the external generative output engine may be obtained. In response to the generative response indicating that the completion criterion has not been satisfied, a next node may be identified of the first set of nodes using the generative response and identify a second set of nodes having an edge with the next node. In response to the generative response indicating that the completion criterion has been satisfied, a set of suggested subtasks may be generated using the generative response. Display may be caused in the graphical user interface of the set of suggested subtasks. In response to an additional user input, a set of new child issues may be caused to be generated in the issue tracking system, each respective child issue of the set of new child issues corresponding to a respective task of the set of suggested subtasks.

In some embodiments, the prompt is a first prompt and the method may also include: in accordance with the completion criterion not being satisfied, generate a second prompt comprising; the predefined query prompt text including the request to rank nodes and the completion criterion; and content extracted from the second set of nodes; obtain an updated generative response from the external generative output engine; in response to the updated generative response indicating that the completion criterion has been satisfied, generate the set of suggested subtasks using the updated generative response; and cause display in the graphical user interface of the set of suggested subtasks.

In some examples, the method also includes: in accordance with identifying the first set of nodes, evaluate permissions with respect to a current user providing the user input; in response to the current user satisfying a permissions criterion, query a database to obtain content from each node of the first set of nodes, the content of each node corresponding to a respective platform; and hydrating the prompt to include the queried content.

In some cases, the prompt includes a request to select a top ranking from the first set of nodes. In some examples, the content graph is generated using content from an issue tracking platform, a content collaboration platform, a project management platform, and an external platform. In some cases, each suggested subtask of the set of suggested subtasks includes a reference to an existing issue or an existing document. In some examples, the prompt may include metadata having an issue type corresponding to each node of the first set of nodes.

A method for automatically generating subtasks in an issue tracking platform based on a parent issue and context extracted from a plurality of platforms is described herein. The method may include: receiving a user input comprising the parent issue and a request to create a list of subtasks based on the parent task of the task; in response to the request to create the list of subtasks, retrieving a first resource identifier based on data from the task; querying a content graph using the first resource identifier to obtain a second resource identifier, the second resource identifier having an edge relationship with respect to the first resource identifier, the content graph generated from content from at least two of the issue tracking platform, a content collaboration platform, or a project management platform; generating a first prompt including the parent task, content from the first resource identifier, content from the second resource identifier, and predefined content having a completion criterion; submitting the first prompt to an external generative output engine using an application programming interface call; obtaining a first generative response from the external generative output engine; in response to the first generative response indicating that the completion criterion has not been satisfied, querying the content graph using the second resource identifier to obtain a third resource identifier, the second resource identifier having an edge relationship with respect to the first resource identifier; generating a second prompt including at least a portion of the content from the first prompt and content from the third resource identifier; in response to receiving a second generative response from the external generative output engine indicating that the completion criterion has been satisfied, analyzing the second generative response to identify a suggested subtask; and causing display, in a graphical user interface, of the suggested subtask, the suggested subtask including a reference to a particular document or issue.

In some cases, the second resource identifier is a plurality of second resource identifiers, each second resource identifier representing a respective node in the content graph, and the first prompt also includes a request to rank the plurality of second resource identifiers. In some examples, the first prompt includes a filter criterion and in response to receiving the first prompt comprising content from the plurality of second resource identifiers, a sub-plurality of second resource identifiers satisfying the filter criterion may be selected. In some cases, the method may include causing a child issue to be generated in the issue tracking platform, the generated child issue corresponding to the suggested subtask. In some variations, the child issue may be associated with an issue corresponding to the first resource identifier. In some examples, the content graph is updated to include the generated child issue.

In some examples, the method includes: in accordance with identifying the second resource identifier, evaluating permissions with respect to a current user providing the user input; in response to the current user satisfying a permissions criterion, querying a database to obtain content corresponding to the second resource identifier, the second resource identifier associated with the content collaboration platform; and hydrating the first prompt to include the queried content.

Under some embodiments describes herein, a method for generating a set of child issues based on a parent issue using generative tools includes: causing display of the parent issue in a graphical user interface of an issue tracking system; in response to a textual input provided to the graphical user interface, the textual input including at least a reference to the parent issue; receiving a request to create a set of subtasks based on the parent issue; identifying a resource identifier based on data from the parent issue; accessing a first node of a content graph corresponding to the resource identifier; identifying, using the content graph, at least one related node having an edge with respect to the first node; obtaining content corresponding to the at least one related node from a respective platform; generating a prompt includes a predefined query prompt text including a completion criterion, and content obtained from the at least one related node; sending the prompt to an external generative output engine; obtaining a generative response from the external generative output engine including an indication that the completion criterion is not satisfied; obtaining subsequent nodes from the content graph based on a prior node; iteratively sending subsequent prompts using content obtained from the subsequent nodes, until a subsequent generative response indicates satisfaction of the completion criterion; in response to satisfying the completion criterion, generate a set of suggested subtasks using the subsequent generative response; and cause display in the graphical user interface of the set of suggested subtasks.

In some cases, in accordance with identifying the at least one related node and the subsequent nodes, permissions may be evaluated with respect to a current user. In response to the current user satisfying a permissions criterion, a database may be queried to obtain content from each node of the at least one related node and the subsequent nodes, the content of each node corresponding to a respective platform. Each subsequent prompt may then be hydrated to include the queried content.

In some examples, content graph is generated using data from an issue tracking platform, a content collaboration platform, a software management platform, and a software development platform. In some embodiments, a first node of the at least one related node is a pull request. Under some examples, the external generative output engine is a large language model. In some cases, a branch of nodes is excluded from a subtask generation based on a relationship between a parent node and a first subsequent node.

### DETAILED DESCRIPTION

Embodiments described herein relate to systems and methods for automatically creating a list of suggested child tasks or subtasks based on a parent issue using a large language model. The large language model leverages both the content from the parent issue and content from multiple software platforms to generate specific tasks having references to particular documents, commits, issues, and the like. The list of suggested child tasks may be generated into individual issues in an issue tracking platform having a relationship with respect to the parent issue.

Work in modern enterprises is often driven by a need of the enterprise's customer base, a need to improve offerings, a need to expand into new markets, and the like. In a macro scale, these needs generate work within the organization, that is typically organized into projects. Project goals and timelines are typically defined by individuals in a managerial role. For example, a particular project may focus on building additional functionality for an issue tracking platform of the organization. In this example, the project may focus on adding a smooth integration with a third party authentication system within the issue tracking platform to make it easier for users to access the platform.

Traditional systems for defining subtasks may be time consuming, inefficient and inaccurate. This problem is compounded by the size of an organization, by the complexity of the project, and by the tools used in those organizations to enhance collaboration and productivity. For example, an organization may use multi-platform federated systems, including a content collaboration platform, an issue tracking platform, a project management platform, a software development platform, whiteboards, calendars, emails, and so on. Each of these platforms have distinct functions and generate a large amount of content on a daily basis. In many cases, a project may have a tens, if not hundreds, of interrelated projects, each of which may be associated with hundreds, if not thousands, of issues, documents, lines of code, and the like. Thus, while a project manager may have a baseline knowledge about what documents, issues, or resources can be leveraged by the team to carry out the project, compiling a complete list of resources is impracticable. Such list may take months of scouring each platform to find resources, it is subject to human error, and it can result in undue delays of the project. This results in inefficiencies (e.g., due to repeated work, lost knowledge base about best practices), delays in the project, and may result in data incompatibilities as content is gathered from multiple distinct software platforms.

The systems and methods described herein may be configured to analyze a parent issue (e.g., a write-up of a project, its goals, its milestones) and break down the parent issue into specific subtasks. In particular, the systems and methods leverage large language models to generate these subtasks by feeding the large language model with the task and with context extracted from federated platforms. Both the parent issue and the context guide the large language model to generate specific subtasks, including references to documents, issues, or other content that can be leveraged to complete the subtask. As a general matter, the more context provided to the large language model, the more detailed each subtask will be. Accordingly, the system may employ an iterative process to expand on the context, as needed, to reach enough level of detail such that the subtask is useful to the individuals performing them.

As an example of a method described herein, a user of an issue tracking system may first develop a task (e.g., a parent issue) outlining a problem, the expected goal to solve the problem, milestones, budget, and the like. Once the parent issue is created, a user may trigger the generation of subtasks by selecting a button within the issue tracking system, for example. From here, a backend system may access a content node graph to extract context needed prior to generating a prompt for a large language model.

As described herein, a content node graph refers to a data structure that maps the relationships of individual items (e.g., content items) from each platform with respect to other individual items from the same or any other federated platform in an organization's suite. Each individual data item represents a node in the graph and the relationship between a node and another node is an edge. For example, a first node in the content node graph may represent a document in a content collaboration platform. This document may be linked (e.g., have an edge relationship) to a particular space in the content collaboration platform, a particular user, an issue item in the issue tracking platform, and a pull request from a code execution and revision control resource. Each of these related items, in turn, may be related to each other, and to other items. In some embodiments, the relationship between an individual item and another item may be reflected in the graph.

Generally, the parent issue may include at least one reference to an existing issue item, document, project, or the like. Upon requesting the generation of subtasks, a prompt generation service obtains a unique identifier to this node (e.g., a reference to the existing issue item in the issue tracking platform). From the node, the prompt generation service accesses the content node graph to obtain other nodes with a relationship to the initial node. For example, the parent issue may be associated with an issue item having a unique identifier 1234. From the unique identifier, the prompt generation service can pinpoint its location in the content graph and obtain other nodes with an edge relationship to 1234 (e.g., identifiers 5678 and 9012). Once the identifier for the other nodes are obtained, content related to those unique identifiers is retrieved. For example, identifier 5678 may have content related to a document in a content collaboration platform.

A prompt may then be generated that includes a predefined query which sets up the request to create subtasks, defines an acceptance criteria for an acceptable output (e.g., based on the level of specificity in the task required), and requests a ranking of results, for example. The generated prompt also includes content from the parent issue (e.g., all the content, summarized content, content with relevant portions extracted thereof). Also, the generated prompt includes content extracted from the initial node (e.g., 1234) and from the other nodes (e.g., 5678 and/or 9012). The content from the nodes may be referred as the context to the parent issue. More specifically, the context provides insight to the parent issue such that more detailed subtasks can be created. The context also informs the accuracy of the output from a generative output engine.

Once the prompt is generated, the prompt is sent to a generative output engine, such as a large language model. In some cases, the generative output engine may be a third-party service, such as described herein. The generative output engine then returns a result to the prompt. For example, the generative output engine may determine (e.g., based on the acceptance criteria) that enough information was provided and provides subtasks based on the information provided. An example subtask may be, for instance “Create project page template using Template123.docx.” In some cases, however, the generative output engine indicates that a sufficient answer has not been reached and may suggest what the next steps should be. For example, the generative output engine may indicate additional context is needed. In this case, the prompt generation service may fetch a next node (or a group nodes) having an edge with respect to the previous node from the content node graph. The data on the next node is retrieved and provided to the generative output engine.

This iterative process may continue through subsequent nodes until the acceptance criteria is satisfied. Upon satisfying the acceptance criteria, the system receives from the generative output system a set of suggested subtasks, which may be displayed in a graphical user interface of the issue tracking system. In some cases, the generative output engine may be communicatively coupled to the issue tracking system (e.g., via an API) to generate individual issue items for each subtasks and relate those generated issue items to the parent issue (e.g., a parent issue item).

### Scalable Network Architecture for Automatic Content Generation

A system incorporating a generative output engine can be referred to as a “generative output system” or a “generative output platform.” Broadly, the term “generative output engine” may be used to refer to any combination of computing resources that cooperate to instantiate an instance of software (an “engine”) in turn configured to receive a string prompt as input and configured to provide, as deterministic or pseudo-deterministic output, generated text which may include words, phrases, paragraphs and so on in at least one of (1) one or more human languages, (2) code complying with a particular language syntax, (3) pseudocode conveying in human-readable syntax an algorithmic process, or (4) structured data conforming to a known data storage protocol or format, or combinations thereof.

The string prompt (or “input prompt” or simply “prompt”) received as input by a generative output engine can be any suitably formatted string of characters, in any natural language or text encoding.

In some examples, prompts can include non-linguistic content, such as media content (e.g., image attachments, audiovisual attachments, files, links to other content, and so on) or source or pseudocode. In some cases, a prompt can include structured data such as tables, markdown, JSON formatted data, XML formatted data, and the like. A single prompt can include natural language portions, structured data portions, formatted portions, portions with embedded media (e.g., encoded as base64 strings, compressed files, byte streams, or the like) pseudocode portions, or any other suitable combination thereof.

The string prompt may include letters, numbers, whitespace, punctuation, and in some cases formatting. Similarly, the generative output of a generative output engine as described herein can be formatted/encoded according to any suitable encoding (e.g., ISO, Unicode, ASCII as examples).

In these embodiments, a user may provide input to a software platform coupled to a network architecture as described herein. The user input may be in the form of interaction with a graphical user interface affordance (e.g., button or other UI element), or may be in the form of plain text. In some cases, the user input may be provided as typed string input provided to a command prompt triggered by a preceding user input.

### Large Language Models

An example of a generative output engine of a generative output system as described herein may be a large language model (LLM). Generally, an LLM is a neural network specifically trained to determine probabilistic relationships between members of a sequence of lexical elements, characters, strings or tags (e.g., words, parts of speech, or other subparts of a string), the sequence presumed to conform to rules and structure of one or more natural languages and/or the syntax, convention, and structure of a particular programming language and/or the rules or convention of a data structuring format (e.g., JSON, XML, HTML, Markdown, and the like).

More simply, an LLM is configured to determine what word, phrase, number, whitespace, nonalphanumeric character, or punctuation is most statistically likely to be next in a sequence, given the context of the sequence itself. The sequence may be initialized by the input prompt provided to the LLM. In this manner, output of an LLM is a continuation of the sequence of words, characters, numbers, whitespace, and formatting provided as the prompt input to the LLM.

To determine probabilistic relationships between different lexical elements (as used herein, “lexical elements” may be a collective noun phase referencing words, characters, numbers, whitespace, formatting, and the like), an LLM is trained against as large of a body of text as possible, comparing the frequency with which particular words appear within N distance of one another. The distance N may be referred to in some examples as the token depth or contextual depth of the LLM.

In many cases, word and phrase lexical elements may be lemmatized, part of speech tagged, or tokenized in another manner as a pretraining normalization step, but this is not required of all embodiments. Generally, an LLM may be trained on natural language text in respect of multiple domains, subjects, contexts, and so on; typical commercial LLMs are trained against substantially all available internet text or written content available (e.g., printed publications, source repositories, and the like). Training data may occupy petabytes of storage space in some examples.

As an LLM is trained to determine which lexical elements are most likely to follow a preceding lexical element or set of lexical elements, an LLM must be provided with a prompt that invites continuation. In general, the more specific a prompt is, the fewer possible continuations of the prompt exist. For example, the grammatically incomplete prompt of “can a computer” invites completion, but also represents an initial phrase that can begin a near limitless number of probabilistically reasonable next words, phrases, punctuation and whitespace. A generative output engine may not provide a contextually interesting or useful response to such an input prompt, effectively choosing a continuation at random from a set of generated continuations of the grammatically incomplete prompt.

By contrast, a narrower prompt that invites continuation may be “can a computer supplied with a 30 W power supply consume 60 W of power?” A large number of possible correct phrasings of a continuation of this example prompt exist, but the number is significantly smaller than the preceding example, and a suitable continuation may be selected or generated using a number of techniques. In many cases, a continuation of an input prompt may be referred to more generally as “generated text” or “generated output” provided by a generative output engine as described herein.

Generally, many written natural languages, syntaxes, and well-defined data structuring formats can be probabilistically modeled by an LLM trained by a suitable training dataset that is both sufficiently large and sufficiently relevant to the language, syntax, or data structuring format desired for automatic content/output generation.

In addition, because punctuation and whitespace can serve as a portion of training data, generated output of an LLM can be expected to be grammatically and syntactically correct, as well as being punctuated appropriately. As a result, generated output can take many suitable forms and styles, if appropriate in respect of an input prompt.

Further, as noted above in addition to natural language, LLMs can be trained on source code in various highly structured languages or programming environments and/or on data sets that are structured in compliance with a particular data structuring format (e.g., markdown, table data, CSV data, TSV data, XML, HTML, JSON, and so on).

As with natural language, data structuring and serialization formats (e.g., JSON, XML, and so on) and high-order programming languages (e.g., C, C++, Python, Go, Ruby, JavaScript, Swift, and so on) include specific lexical rules, punctuation conventions, whitespace placement, and so on. In view of this similarity with natural language, an LLM generated output can, in response to suitable prompts, include source code in a language indicated or implied by that prompt.

For example, a prompt of “what is the syntax for a while loop in C and how does it work” may be continued by an LLM by providing, in addition to an explanation in natural language, a C++ compliant example of a while loop pattern. In some cases, the continuation/generative output may include format tags/keys such that when the output is rendered in a user interface, the example C++ code that forms a part of the response is presented with appropriate syntax highlighting and formatting.

As noted above, in addition to source code, generative output of an LLM or other generative output engine type can include and/or may be used for document structuring or data structuring, such as by inserting format tags (e.g., markdown). In other cases, whitespace may be inserted, such as paragraph breaks, page breaks, or section breaks. In yet other examples, a single document may be segmented into multiple documents to support improved legibility. In other cases, an LLM generated output may insert cross-links to other content, such as other documents, other software platforms, or external resources such as websites.

In yet further examples, an LLM generated output can convert static content to dynamic content. In one example, a user-generated document can include a string that contextually references another software platform. For example, a documentation platform document may include the string “this document corresponds to project ID 123456, status of which is pending.” In this example, a suitable LLM prompt may be provided that causes the LLM to determine an association between the documentation platform and a project management platform based on the reference to “project ID 123456.”

In response to this recognized context, the LLM can wrap the substring “project ID 123456” in anchor tags with an embedded URL in HTML-compliant syntax that links directly to project 123456 in the project management platform, such as: “<a href=′https://example link/123456>project 123456</a>”.

In addition, the LLM may be configured to replace the substring “pending” with a real-time updating token associated with an API call to the project management system. In this manner, this manner, the LLM converts a static string within the document management system into richer content that facilitates convenient and automatic cross-linking between software products, which may result in additional downstream positive effects on performance of indexing and search systems.

In further embodiments, the LLM may be configured to generate as a portion of the same generated output a body of an API call to the project management system that creates a link back or other association to the documentation platform. In this manner, the LLM facilities bidirectional content enrichment by adding links to each software platform.

More generally, a continuation produced as output by an LLM can include not only text, source code, pseudocode, structured data, and/or cross-links to other platforms, but it also may be formatted in a manner that includes titles, emphasis, paragraph breaks, section breaks, code sections, quote sections, cross-links to external resources, inline images, graphics, table-backed graphics, and so on.

In yet further examples, static data may be generated and/or formatted in a particular manner in a generative output. For example, a valid generative output can include JSON-formatted data, XML-formatted data, HTML-formatted data, markdown table formatted data, comma-separated value data, tab-separated value data, or any other suitable data structuring defined by a data serialization format.

### Example System Architecture

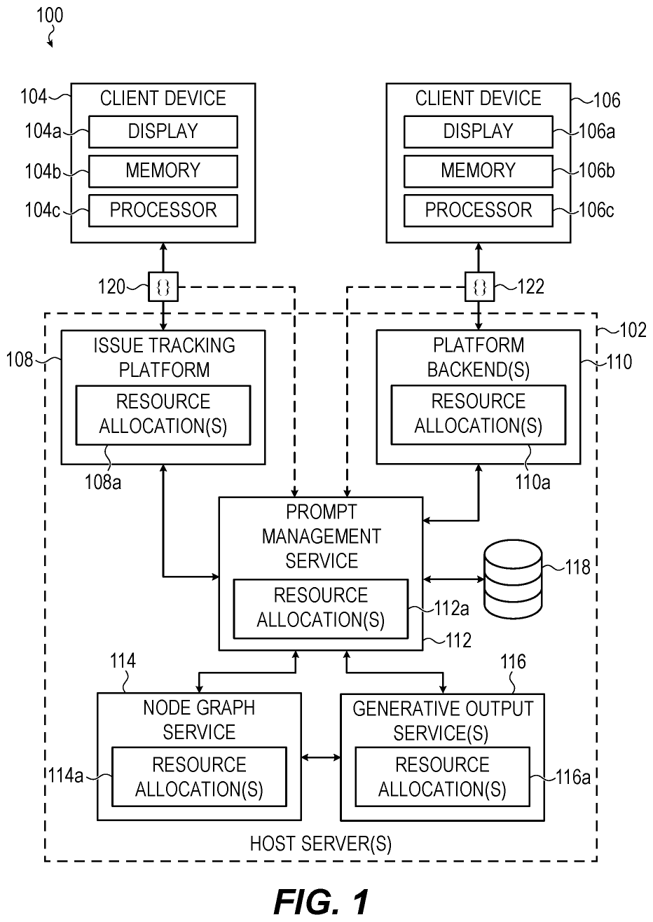

FIG. 1 depicts a simplified diagram of a system 100, such as described herein that can include and/or may generate subtasks using a generative output engine from input from a parent issue and other related context. The system 100 is depicted as implemented in a client-server architecture, but it may be appreciated that this is merely one example and that other communications architectures are possible.

The system 100 includes a set of host servers 102 which may be one or more virtual or physical computing resources (collectively referred in many cases as a “cloud platform”). In some cases, the set of host servers 102 can be physically co-located or in other cases, each may be positioned in a geographically unique location.

The set of host servers 102 can be communicably coupled to one or more client devices; two example devices are shown as the client device 104 and the client device 106. The client devices 104, 106 can be implemented as any suitable electronic device. In many embodiments, the client devices 104, 106 are personal computing devices such as desktop computers, laptop computers, or mobile phones.

The set of host servers 102 can be supporting infrastructure for one or more backend applications, each of which may be associated with a particular software platform, such as a documentation platform or an issue tracking platform. Other examples include ITSM systems, chat platforms, messaging platforms, and the like. These backends can be communicably coupled to a generative output engine that can be leveraged to provide unique intelligent functionality to each respective backend. For example, the generative output engine can be configured to receive user prompts, such as described above, to modify, create, or otherwise perform operations against content stored by each respective software platform. Further, the generative output engine can be used to generate subtasks based on a parent issue and context associated with the parent issue.

Turning to FIG. 1, a portion of the set of host servers 102 can be allocated as physical infrastructure supporting an issue tracking platform 108 and a different portion of the set of host servers 102 can be allocated as physical infrastructure supporting a other platform(s) backend 110. In some examples, other platform(s) may refer to any of a content collaboration platform, a software management platform, a project management platform, a blackboard service, and the like.

Each of the platforms, 108 and 110, maybe instantiated over physical resources provided by the set of host servers 102. Once instantiated, respective frontends for each of the platforms are rendered.

More specifically, the issue tracking platform 108 backend can be configured to communicably couple to an issue tracking platform frontend instantiated by cooperation of a memory and a processor of the client device 104. Once instantiated, the issue tracking platform frontend can be configured to leverage a display of the client device 104 to render a graphical user interface so as to present information to a user of the client device 104 and so as to collect information from a user of the client device 104. Collectively, the processor, memory, and display of the client device 104 are identified in FIG. 1 as the client devices resources 104a-104c, respectively.

As with many embodiments described herein, the issue tracking platform frontend can be configured to communicate with the issue tracking platform 108. In many embodiments, as noted above, the client device 104 and in particular the first platform frontend can be configured to send an authentication token 120 along with each request transmitted to any of the issue tracking platform 108, a prompt management service 112, and the like.

Similarly, the other platform(s) backend 110 can be configured to communicably couple to a respective platform frontend instantiated by cooperation of a memory and a processor of the client device 106. Once instantiated, the respective platform frontend can be configured to leverage a display of the client device 106 to render a graphical user interface so as to present information to a user of the client device 106 and so as to collect information from a user of the client device 106. Collectively, the processor, memory, and display of the client device 106 are identified in FIG. 1 as the client devices resources 106a-106c, respectively.

As with many embodiments described herein, the respective platform(s) frontend can be configured to communicate with other platform(s) backend 110. Information can be transacted by and between the frontend, the other platform(s) backend 110 and a prompt management service 112 in any suitable manner or form or format. In many embodiments, as noted above, the client device 106 and in particular the respective platform frontend can be configured to send an authentication token 122 along with each request transmitted to any of the other platform(s) backend 110 or the prompt management service 112.

A prompt management service 112 can be configured to receive user input (provided via a graphical user interface of the client device 104 or the client device 106) from the issue tracking platform 108. The user input may cause the prompt management service 112 to generate a prompt to be submitted and performed by the generative engine service 116.

The prompt management service 112 can be configured to modify the user input, and to supplement the user input, such as by accessing a node graph 114 and identifying edge nodes and accessing a database (e.g., database 118) corresponding to content of the issue tracking platform 108 or other platform(s) backends 110 to obtain information corresponding to those edge nodes. A node graph 114 may be traversed by the prompt management service 112 to obtain relationships between particular reference issues or document (e.g., from the parent issue) with respect to other issues, documents, pull requests, spaces, and the like. The relationships represented in graph can be leveraged by the prompt management service 112 to obtain additional, often relevant content from the database 118 and other resources and provide context to the generative output engine.

Additionally, the prompt management service 112 can be configured to select a prompt from a database (e.g., the database 118) based on the user input, insert context into a template prompt, and so on. The prompt management service 112 may also be referred to herein as herein as a “prompt constructor” or as a “prompt management agent.” In some cases, the prompt management service 112 is also referred to as a “content creation and modification service.”

Output of the prompt management service 112 can be referred to as a hydrated prompt. This modified prompt can be provided to the generative engine service 116 as an input. More particularly, the prompt management service 112 is configured to structure an API request to the generative engine service 116. The API request can include the modified prompt as an attribute of a structured data object that serves as a body of the API request. Other attributes of the body of the API request can include, but are not limited to: an identifier of a particular LLM or generative engine to receive and continue the modified prompt; a user authentication token; a tenant authentication token; an API authorization token; a priority level at which the generative engine service 116 should process the request; an output format or encryption identifier; and so on. One example of such an API request is a POST request to a Restful API endpoint served by the generative engine service 116. In other cases, the prompt management service 112 may transmit data and/or communicate data to the generative engine service 116 in another manner (e.g., referencing a text file at a shared file location, the text file including a prompt, referencing a prompt identifier, referencing a callback that can serve a prompt to the generative engine service 116, initiating a stream comprising a prompt, referencing an index in a queue including multiple prompts, and so on; many configurations are possible).

In response to receiving a hydrated prompt as input, the generative engine service 116 can execute an instance of a generative output engine, such as an LLM. As noted above, in some cases, the prompt management service 112 can be configured to specify what engine, engine version, language, language model or other data should be used to continue a particular modified prompt. The selected LLM or other generative engine continues the input prompt and returns that continuation to the caller, which in many cases may be the prompt management service 112.

As described herein, a generative output engine service 116 may be hosted over the host servers 102 or, in other cases, may be a software instance instantiated over separate hardware. In some cases, the generative engine service may be a third party service that serves an API interface to which one or more of the host services can communicably couple.

The generative output engine can be configured as described above to provide any suitable output, in any suitable form or format. Examples include generating subtasks for projects, causing to create child issues based on generated subtasks, and the like.

For example, as noted above, the generative engine service 116 can be used to generate content, supplement content, and/or generate API requests or API request bodies that cause one or more actions, such as generating subtasks and cause issues to be created in the issue tracking platform 108. In some cases, an API request generated at least in part by the generative engine service 116 can be directed to another system not depicted in FIG. 1. For example, the API request can be directed to a third-party service (e.g., referencing a callback, as one example, to either backend platform) or an integration software instance.

In some cases, output of the generative engine service 116 can be provided to an output processor or gateway configured to generate tasks in the issue tracking platform 108. For example, output of the generative engine service 116 can be inserted into an API request directly to a backend associated with the issue tracking platform 108. The API request can cause the backend of the documentation system to update an internal object representing the issues to be created. Once created, a frontend may be updated so that a user of the client device can review and consume the generated content.

More generally, the embodiments described herein and with particular reference to FIG. 1 relate to systems for creating a parent issue outlining goals and providing details on the task to be completed, collecting relationship identifiers via a node graph that can be used to fetch content from other platforms and/or associated databases, and compiling the context and the parent issue into a prompt to be submitted to a trained large language model. Output of the LLM can be used to further fetch more content and/or to create subtasks to the parent issue.

These foregoing embodiments depicted in FIG. 1 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

For example, it may be appreciated that all software instances described above are supported by and instantiated over physical hardware and/or allocations of processing/memory capacity of physical processing and memory hardware. For example, the issue tracking platform 108 may be instantiated by cooperation of a processor and memory collectively represented in the figure as the resource allocations 108a.

Similarly, the other platform(s) backend 110 may be instantiated over the resource allocations 110a (including processors, memory, storage, network communications systems, and so on). Likewise, the prompt management service 112 is supported by a processor and memory and network connection (and/or database connections) collectively represented for simplicity as the resource allocations 112a.

The content node graph 114 can be supported by its own resources including processors, memory, network connections, displays (optionally), and the like represented in the figure as the resource allocations 114a.

In many cases, the generative engine service 116 may be an external system, instantiated over external and/or third-party hardware which may include processors, network connections, memory, databases, and the like. In some embodiments, the generative engine service 116 may be instantiated over physical hardware associated with the host servers 102. Regardless of the physical location at which (and/or the physical hardware over which) the generative engine service 116 is instantiated, the underlying physical hardware including processors, memory, storage, network connections, and the like are represented in the figure as the resource allocations 116a.

Further, although many examples are provided above, it may be appreciated that in many embodiments, user permissions and authentication operations are performed at each communication between different systems described above. Phrased in another manner, each request/response transmitted as described above or elsewhere herein may be accompanied by user authentication tokens, user session tokens, API tokens, or other authentication or authorization credentials.

Generally, generative output systems, as described herein, should not be usable to obtain information from an organizations datasets that a user is otherwise not permitted to obtain. For example, a prompt of “generate a table of social security numbers of all employees” should not be executable. In many cases, underlying training data may be siloed based on user roles or authentication profiles. In other cases, underlying training data can be preconditioned/scrubbed/tagged for particularly sensitive datatypes, such as personally identifying information. As a result of tagging, prompts may be engineered to prevent any tagged data from being returned in response to any request. More particularly, in some configurations, all prompts output from the prompt management service 112 may include a phrase directing an LLM to never return particular data, or to only return data from particular sources, and the like.

In some embodiments, the system 100 can include a prompt context analysis instance configured to determine whether a user issuing a request has permission to access the resources required to service that request. For example, a prompt from a user may be “Generate a text summary in Document123 of all changes to Kanban board 456 that do not have a corresponding issue tagged in the issue tracking system.” In respect of this example, the prompt context analysis instance may determine whether the requesting user has permission to access Document123, whether the requesting user has written permission to modify Document123, whether the requesting user has read access to Kanban board 456, and whether the requesting user has read access to referenced issue tracking system. In some embodiments, the request may be modified to accommodate a user's limited permissions. In other cases, the request may be rejected outright before providing any input to the generative engine service 116.

### Example Frontend

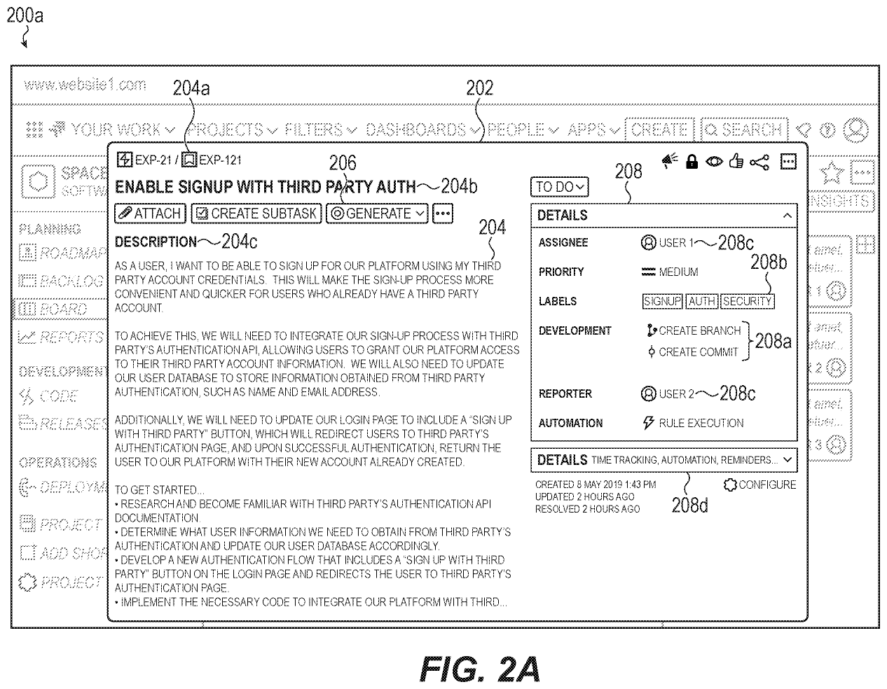

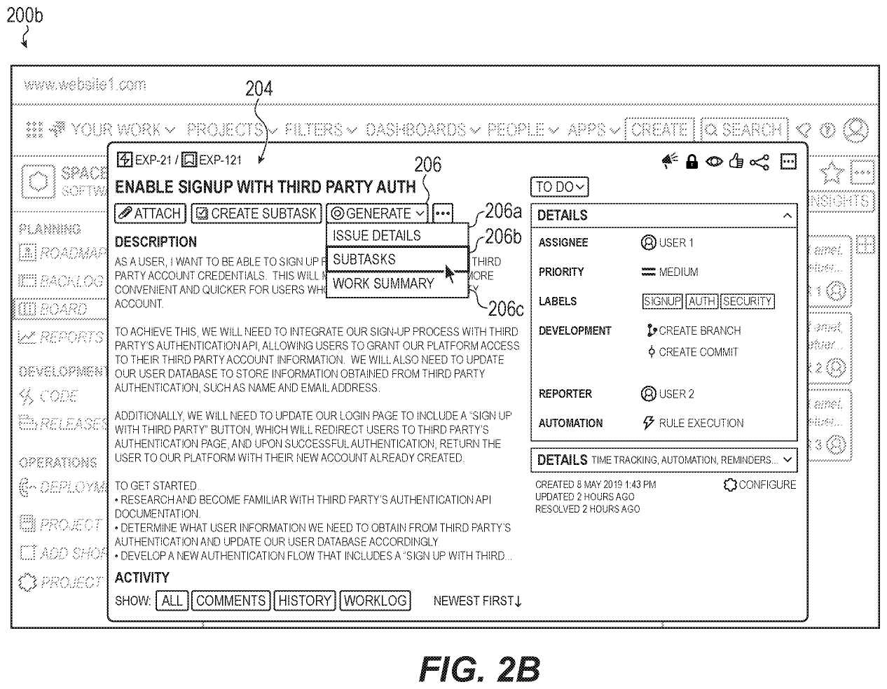

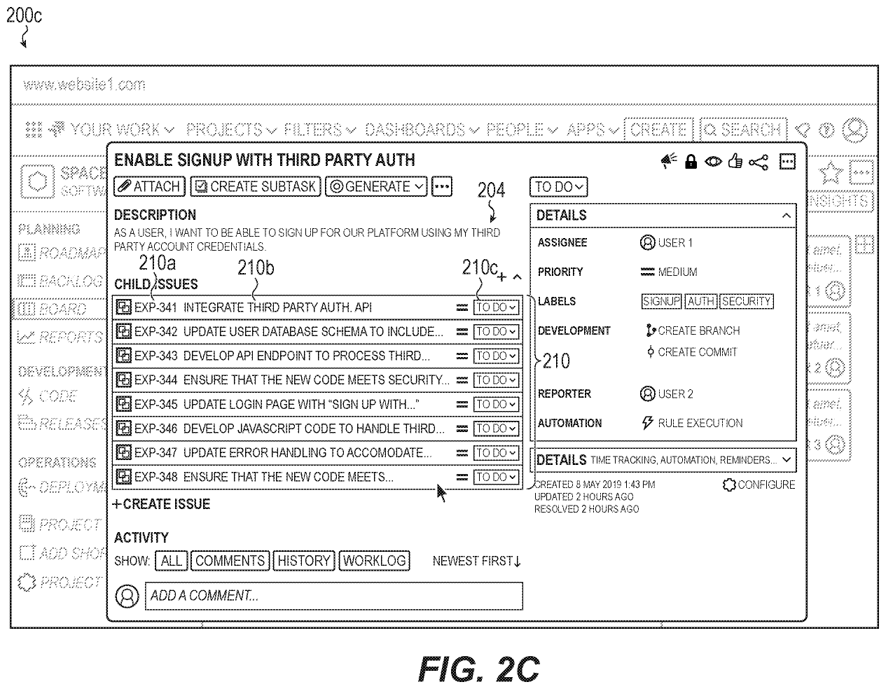

FIGS. 2A-2C depict example frontend interfaces of an issue tracking platform that can initiate and/or interact with a prompt management service and a generative output engine to generate subtasks.

As depicted in FIG. 2A, an issue tracking platform interface 200a may allow a user to create a parent issue 204 which is displayed in a window 202 within the issue tracking platform interface 200a. The parent issue may be also referred to as a parent task or simply an issue. As depicted herein, the frontend application of an issue tracking platform can be a native application, a browser application, or other application type instantiated over hardware directly or indirectly, such as within an operating system environment.

In some cases, the parent issue 204 may be created from an existing issue (e.g., related issue), and/or from other sources. Generally, the parent issue 204 may include task or issue content including, for example, a unique identifier 204a, a title 204b, and a description 204c. The description 204c may include general details about the task or project. For example, as depicted in the figure, a parent issue may include a general goal of “being able to sign up to out platform using my third party account credentials.” The parent issue further describes requirements of this goal, such as integrating the platform's sign-up process with the third party's authentication API and generating a login page that can redirect the user to the third party's authentication page. The parent issue may include some start-up tasks for the project. Generally, the more detailed the parent issue, the more content can be submitted to the generative output engine, resulting in a more pointed set of subtasks to the outlined goals.

Once the user creates the parent issue 204 in in the issue tracking platform, the parent issue 204 may be associated with other content and/or metadata 208. For example, a parent issue 204 may include links to content items managed by other software management platforms, such as branch and commits 208a, labels 208b, users associated with the task 208c (e.g., assignees, reporters), other keywords and/or details 208d, related issues, and the like. More generally, each issue item within the issue tracking platform may include corresponding issue content and/or metadata. This information and/or metadata may be leveraged by a node content graph to establish relationships. For example, each reference 208a-d may be an edge node with respect to a particular node representing the parent issue 204.

The window 202 may include a top menu that includes a series of user action inputs that enables a user to attach files, create subtasks, and/or generate 206 other items by leveraging the generative output engine. As depicted in in FIG. 2B, the issue tracking platform user interface 200b may include a drop-down menu of the generate 206 user input. The generate 206 user input may include an action for generating issue details 206a, generating a work summary 206b, and generating subtasks 206c. Each of these actions may cause a prompt to be generated (e.g., by the prompt management service 112 from FIG. 1) and submitted to the generative output engine to receive an output.

As shown in FIG. 2B, the generate 206 user input may be a selectable button. Upon a user selecting this button, a list of subtasks can be automatically generated without additional input from the user. In other words, a backend system may leverage the existing data in the parent issue, as well as other content extracted from different platforms or sources (as explained below) to generate subtasks. In some embodiments, a selection of a generate 206 control may prompt the user to supply additional data, such as known issues or families which can be used to model subtasks from, an acceptance criteria, a maximum or minimum number of subtasks, and the like.

FIG. 2C depicts an example graphical user interface 200c of an issue tracking system with automatically generated subtasks. This view shows the generated child issues 210 based on suggested subtasks. The suggested subtasks are, in turn, output based on generative content received from the generative output engine after the user selects the generate subtasks 206c control. As depicted, each child issue generated may include a unique identifier 210a, a description 210b, a status 210c, and the like. In some cases, each of the child issues 210 listed may be created within the issue tracking system and linked to the parent issue 204.

As described in more detail below, the generative output engine receives the parent issues, context, and other content from a prompt management service to generate detailed subtasks. Continuing in the example of third party authentication integration, subtasks may include developing an API endpoint to process the third party authentication, ensure code meets security standards, develop Javascript code, and the like. In some examples, the task “developing an API endpoint to process the third party authentication” may include a specific reference to an existing API endpoint which the user can leverage to make work more efficient. Similarly, the security standards task may include particular references to documentation in an issue tracking platform such that the user has the most up-to-date standards to complete the quality control work. As yet another example, the developing Javascript code may refer to another issue in an issue tracking platform and/or an external website to the third-party platform that walks the user through the process of developing the Javascript code to handle the particular third-party integration. In some examples, each child task 210 may include an assignee for the task, which may be based on the personnel assigned to the project (e.g., with respect to the parent issue), prior expertise with the particular subtask, department, workload, and the like.

### Example Methods and Systems for Generating Subtasks Using Generative Output

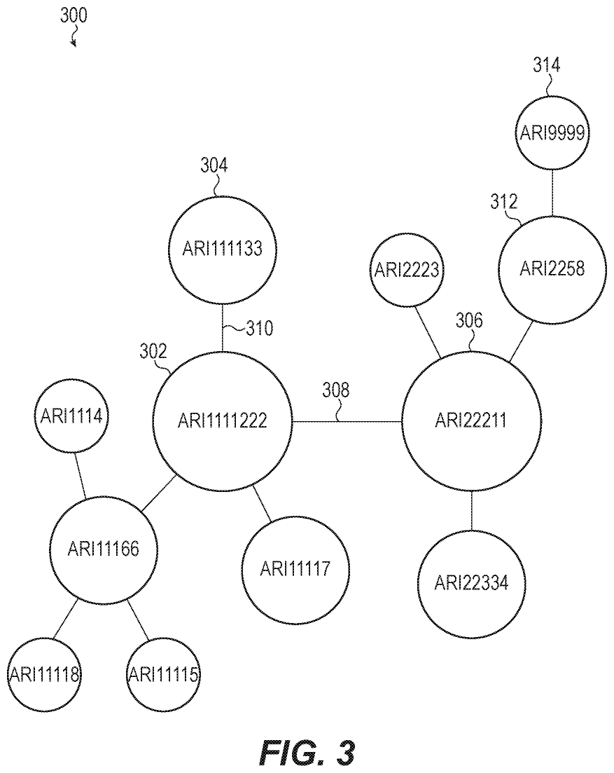

As discussed above, a prompt management service generates prompts to submit (e.g., via an API) to a generative output engine. To create detailed subtasks (e.g., manageable tasks having with particular references to existing documents, issues, pull requests, and the like that guides the assignee on performing the task), such as described above, the prompt includes the description from the parent issues (and related metadata, for example) as well as context. In some embodiments, as described herein, context is obtained from other platform(s) backends and data from the server system 102. The prompt management service is guided by a content node graph to fetch the particular data from each of these platforms that can provide the most relevant and/or useful context for the prompt. FIG. 3 depicts a simplified example of a content node graph 300.

A content node graph 300 is a map of relationships of content items associated with various platforms, internal and external to the organization. As depicted in FIG. 3, a content node graph 300 may include nodes (e.g., nodes 302, 304, 306, 312, and 314) having a relationship (e.g., edges 308, 310) with respect to at least one other node. For example, node 302 has a relationship with respect to, at least, nodes 304 and 306. Each node in the graph 300 is associated with a global resource identifier. For example, ARI1111222, ARI22211, ARI111133, and so on. Each of the global resource identifiers corresponds to a particular content item in any one of the platforms or services, such as those described in FIG. 1. For example, global resource identifier ARI 1111222 may correspond to a particular issue item in the issue tracking platform. As another example, global resource identifier ARI111133 may be associated with a particular page within a content collaboration platform. As another example global resource identifier ARI9999 may be associated with a pull request.

The content node graph 300 may include edges, which represent a link or relationship between nodes. For example, node 302 may have an edge 308. Generally, parent issues, spaces, or other items with a higher hierarchy in the respective platform has more edges than subtasks, pages, pull requests, and the like.

In some embodiments, the content node graph may include the relationship type (e.g., an edge type) with respect to two nodes. For example, an edge type may be an issue has document, issue has pull request, space has page, project has team, project has goal, and the like. While dependency relationships are exemplified, other relationships of the graph, such as a relationship between a project and a repository, may be represented.

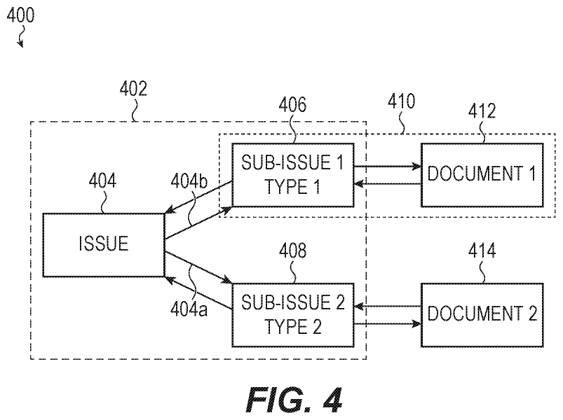

FIG. 4A shows a simplified diagram of an iterative process 400 to generate subtasks described herein. As explained above, a prompt management service first traverses the graph to identify a first global resource identified based on the parent issue. For example, an issue linked to the parent issue. Once the global resource identifier is obtained, the prompt management service obtains the edges to identify other global resource identifiers that can provide context to the generative output engine. As shown in the example of FIG. 4A, the first step 402 may be to obtain the issue 404. The issue 404 has an edge relationship 404b with sub-issue 1 406 and an edge relationship 404a with sub-issue 2 408. The prompt management service may obtain content related to issue 404, sub-issue 1 406, and sub-issue 2 408. This content from each respective item 404, 406, and 408, may be added to the prompt as a way to provide context (e.g., hydrate) to the parent issue content. The prompt, including the context from the first step 402, is provided to the generative output engine along with a completion criteria to determine if the engine has sufficient data to answer the prompt (e.g., generate subtasks).

In some embodiments, the generative output engine may determine that the first step 402 does not provide enough data to reach a satisfactory answer the prompt (e.g., meets an acceptance criteria). In this case, the generative output engine may decide the next steps. For example, the system may determine that it needs to obtain a document linked to the issue items. Further, the system may decide that it needs documents for issue items which are “in progress.” Based on these requirements, a prompt management service may access the node graph again to obtain the next set of edges corresponding to sub-issue 1 406 and sub-issue 2 408.

As depicted in the figure, sub-issue type 1 has an edge with document 1 (e.g., has a document linked to the sub-issue) and sub-issue type 2 has an edge with document 2. In some embodiments, the prompt management service may fetch both documents 412 and 414 and hydrate the prompt with this data. However, in some examples, the generative output engine has further required that the documents should be linked to issues which are “in progress.” In this example, the prompt management service may identify that the sub-issue 1 corresponds to “type 1.” In this example, type 1 may correspond to an “in progress” status. The prompt management service may further identify that sub-issue type 2 is associated with a “type 2,” which may correspond to a “completed” status. Continuing with this example, the prompt management service may filter the content to the branch having document 1 only. Thus, at a second step 410, the prompt is hydrated with the content from document 1 412 and document 2 414 is omitted. The system may analyze generative output produced using the hydrated prompt including content from document 1 412 and decide if this data is sufficient to meet the acceptance criteria. In some cases, the prompt management service may fetch both documents 412 and 414 and provide a hydrated prompt to the generative output engine. In this example, the generative output engine may ignore and/or only consider the content that meets the parameters from its prior decision in this chaining process.

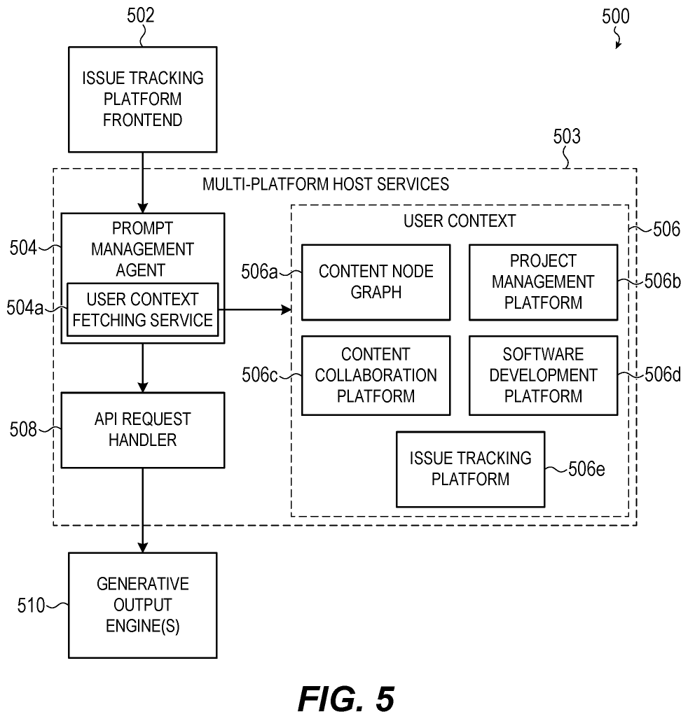

FIG. 5 shows a simplified diagram of a system configured to generate subtasks in an issue tracking system. As explained above, an issue tracking platform frontend 502 may include a selectable control for generating subtasks based on a parent issue. When this selectable control is selected, the issue tracking platform frontend 502 communicates with a centralized multi-platform host services 503 to access a prompt management agent 504. The prompt management agent 504 is operable to access internal content within the multi-platform host services (e.g., from the multiple federated platforms used by the organization), communicate with external services, servers, and/or other API gateways.

The prompt management agent 504 may retrieve context data via a user context fetching service 504a. Data from the parent issue may include a description, an issue identifier associated with the parent issue, and the like. The context fetching service 504a is also configured to access content within databases and/or resource allocations of each of the platform backends to obtain user context 506. In particular, the context fetching service 504a may convert the issue identifier to a global resource identifier. The global resource identifier may then be used as a reference to traverse a content node graph 506a. Once other global resource identifiers within the chain of the initial global identifiers are identified, each of those other global resource identifiers are used to fetch its corresponding documents, issue items, or content from each resource, such as 506b-e. The prompt management agent 504 may then compile the user context, parent issue, and the like to configure a prompt to be submitted to the generative output engine 510. More specifically, the prompt management agent 504 may be configured to submit the prompt to an API request handler 508 which, in turn, communicates with the generative output engine 510.

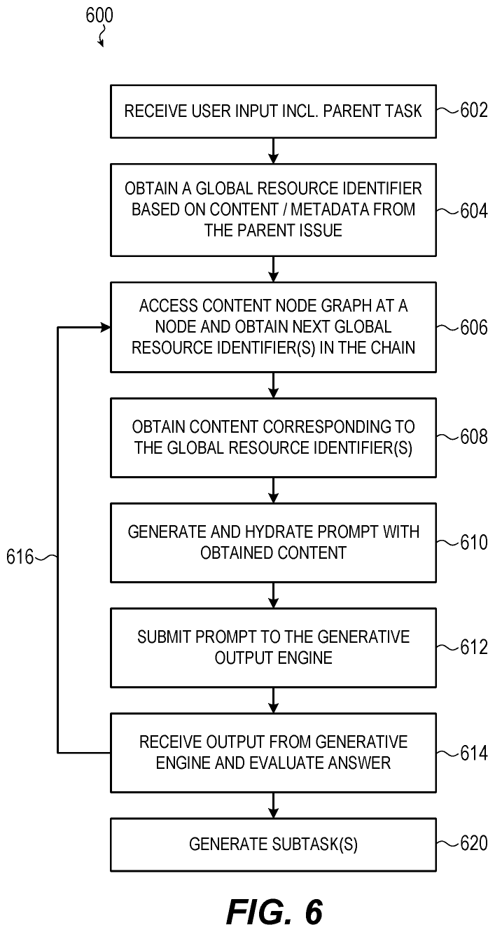

FIG. 6 depicts an example method for generating subtasks, which may leverage the system described above in FIG. 5. At step 602, user input is received including the parent issue. In some cases, the parent issue includes content that explains a project, a task, and the goals. The parent issue may also include related issues, assignees, and other linked data.

At step 604, a global resource identifier is obtained based on the content and/or metadata from the parent issue. In some cases, the global resource identifier is a unique identifier used to traverse a content node graph.

At step 606, the content node graph is accessed at a node corresponding to the global resource identifier. Subsequent global resource identifiers can be determined from nodes having an edge with respect to the initial or reference node. In some cases, only nodes within one level (e.g., one step or edge from) the reference node are identified. In other examples, nodes with two or more levels are identified.

At step 608, the subsequent global resource identifiers obtained from the graph can then be used to obtain more content that serves as context to the prompt. For example, if two nodes with an edge relationship to the initial nodes are identified, the system may obtained the content related to those nodes. In some cases the nodes may correspond to a particular issue, document, page, and the like. The content from these nodes can be utilized as context to the generative output engine. Accessing the content may be subject to the user account having the required authorization to access the content. For example, content may be accessed in response to the user account satisfying permissions criteria with respect to the respective content item.

At step 610, a prompt is generated and/or hydrated with the context obtained. As explained above, the prompt is hydrated with the data obtained in accordance with permissions associated with the user account and data or content for which the user account does not have access may not be added to the prompt. The prompt may be generated based, in part, on a predefined query text. The predefined query text may include an acceptance criteria for answering the prompt. In some cases, the prompt may also include a ranking request of a top set of nodes. In this example, a ranking may be used to reduce the size and/or computing resources required to process a request at each iterative step. For example, nodes associated with hundreds of other nodes may require further ranking and/or filtering to speed up processing.

At step 612, the prompt is submitted to the generative output engine. As described previously, the prompt may be provided to the generative output engine using an application programming interface call. In some cases, the prompt management (e.g., submitting) is managed by a centralized service that controls the inputs submitted to the generative engine and optimizes the number of prompts submitted by the enterprise.

At step 614, output from the generative engine is received and the answer is evaluated. For example, the generative output may be evaluated for completeness including whether one or more additional subtasks can be defined based on the information gathered by the system. In some cases, the generative output may identify a type of content item or an identifier of a particular content item that may include additional information needed for a more complete response. The generative response may also include an indicator of whether the completeness criteria has been satisfied based, at least on part, on the predetermined prompt language provided in the prompt. For example, the completeness criteria may specify that a complete task description, task owner, and/or task title must be obtained before the criteria have been satisfied. In some cases, an amount of detail or length of description criteria may be used as part of the completeness criteria.

In some examples, the output may include a list of suggested tasks. Based on the answer, the prompt manager may determine that additional information should be provided and may return (e.g., step 616) to step 606. By collecting additional context or content, the output may be more detailed and thus more likely to satisfy the acceptance criteria.

If a sufficient answer is provided (e.g., completeness criteria are satisfied), at step 620, the output from the generative engine may be displayed to the user. For example, the generative output may include a list of subtasks or task descriptions that are displayed to the user. In some cases, the system may be further configured to generate one or more sub-issues based on the list of subtasks. Specifically, the system may cause creation of a set of issue objects or content items using the content associated with each subtask using an application programming interface call to the issue tracking system. Each issue may be generated as a child issue of the original parent issue or have another suitable hierarchical relationship to the parent issue. In some examples, the child issues may be automatically assigned to a user, based on project involvement, prior experience, and the like. As child tasks are generated, the child tasks may be assigned a global issue identifier and the node graph may be updated (e.g., upon generating the tasks, on a regular basis, and the like). More generally, the generated child issues and/or the suggested subtasks may be displayed in a graphical user interface of the issue tracking system in accordance with the examples provided herein.

### Multiplatform Management of Generative Input and Output

The above description and examples provided with respect to FIGS. 1-6 focus on generating subtasks using a generative output system. As described below, this system may be part of a multiplatform environment with multiple platform backends and with centralized services that evaluate and queue requests that are input to the one or more generative engines.

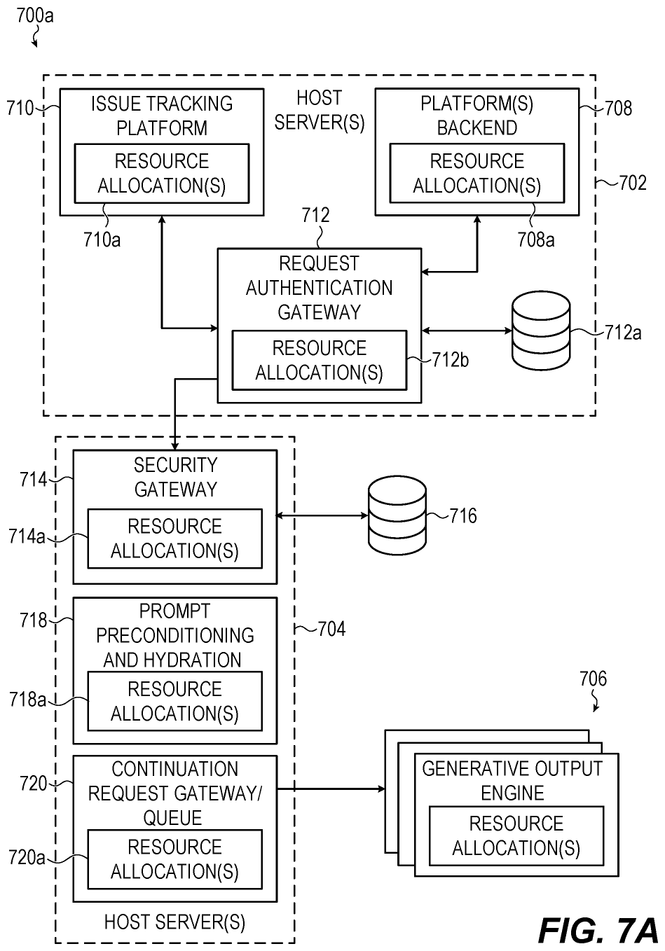

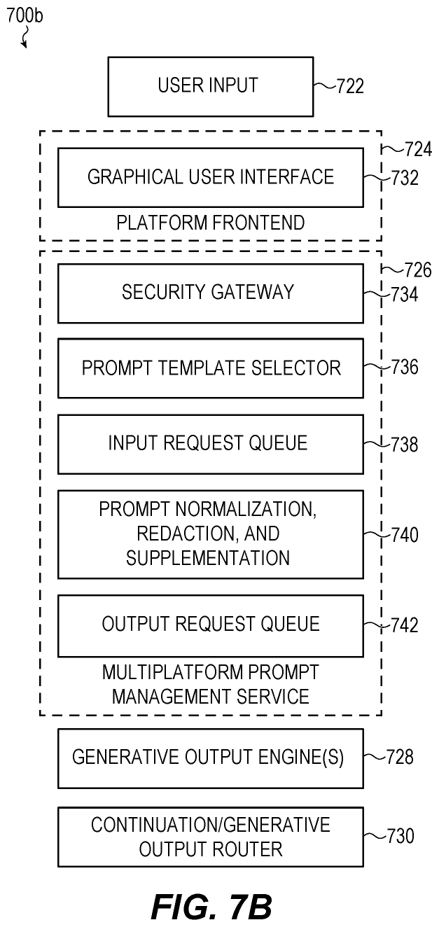

FIGS. 7A-7B depict system diagrams and network/communication architectures that may support a system as described herein. Referring to FIG. 7A, the system 700a includes a first set of host servers 702 associated with one or more software platform backends. These software platform backends can be communicably coupled to a second set of host servers 704 purpose configured to process requests and responses to and from one or more generative output engines 706.

Specifically, the first set of host servers 702 (which, as described above can include processors, memory, storage, network communications, and any other suitable physical hardware cooperating to instantiate software) can allocate certain resources to instantiate a first and second platform backend, such as a first platform backend 708 and a second platform backend 710. Each of these respective backends can be instantiated by cooperation of processing and memory resources associated to each respective backend. As illustrated, such dedicated resources are identified as the resource allocations 708a and the resource allocations 710a.

Each of these platform backends can be communicably coupled to an authentication gateway 712 configured to verify, by querying a permissions table, directory service, or other authentication system (represented by the database 712a) whether a particular request for generative output from a particular user is authorized. Specifically, the second platform backend 710 may be a documentation platform used by a user operating a frontend thereof.

The user may not have access to information stored in an issue tracking system. In this example, if the user submits a request through the frontend of the documentation platform to the backend of the documentation platform that in any way references the issue tracking system, the authentication gateway 712 can deny the request for insufficient permissions. This example is merely one and is not intended to be limiting; many possible authorization and authentication operations can be performed by the authentication gateway 712. The authentication gateway 712 may be supported by physical hardware resources, such as a processor and memory, represented by the resource allocations 712b.

Once the authentication gateway 712 determines that a request from a user of either platform is authorized to access data or resources implicated in service that request, the request may be passed to a security gateway 714, which may be a software instance supported by physical hardware identified in FIG. 7A as the resource allocations 714a. The security gateway 714 may be configured to determine whether the request itself conforms to one or more policies or rules (data and/or executable representations of which may be stored in a database 716) established by the organization.

Once a particular user input (e.g., an input to generate subtasks) has been sufficiently authorized and cleared against organization-specific generative output rules, the request/prompt can be passed to a preconditioning and hydration service 718 configured to populate request-contextualizing data (e.g., user ID, page ID, project ID, URLs, addresses, times, dates, date ranges, and so on), insert the user's request into a larger engineered template prompt and so on. Example operations of a preconditioning instance are described elsewhere herein; this description is not repeated. The preconditioning and hydration service 718 can be a software instance supported by physical hardware represented by the resource allocations 718a. In some implementations, the hydration service 718 may also be used to rehydrate personally identifiable information (PII) or other potentially sensitive data that has been extracted from a request or data exchange in the system.

Once a prompt has been generated and hydrated by the preconditioning and hydration service 718, it may be passed to an output gateway 720 (also referred to as a continuation gateway or an output queue). The output gateway 720 may be responsible for enqueuing and/or ordering different requests from different users or different software platforms based on priority, time order, or other metrics. The output gateway 720 can also serve to meter requests to the generative output engines 706.

FIG. 7B depicts a functional system diagram of the system 700a depicted in FIG. 7A. In particular, the system 700b is configured to operate as a multiplatform prompt management service supporting and ordering requests from multiple users across multiple platforms. In particular, a user input 722 may be received at a platform frontend 724. The platform frontend 724 passes the input to a prompt management service 726 that formalizes a prompt suitable for input to a generative output engine 728, which in turn can provide its output to an output router 730 that may direct generative output to a suitable destination. For example, the output router 730 may execute API requests generated by the generative output engine 728, may submit text responses back to the platform frontend 724, may wrap a text output of the generative output engine 728 in an API request to update a backend of the platform associated with the platform frontend 724, or may perform other operations.

Specifically, the user input 722 (which may be an engagement with a button, typed text input, spoken input, chat box input, and the like) can be provided to a graphical user interface 732 of the platform frontend 724. The graphical user interface 732 can be communicably coupled to a security gateway 734 of the prompt management service 726 that may be configured to determine whether the user input 722 is authorized to execute and/or complies with organization-specific rules.

The security gateway 734 may provide output to a prompt selector 736 which can be configured to select a prompt template from a database of preconfigured prompts, templatized prompts, or engineered templatized prompts. Once the raw user input is transformed into a string prompt, the prompt may be provided as input to a request queue 738 that orders different user request for input from the generative output engine 728. Output of the request queue 738 can be provided as input to a prompt hydrator 740 configured to populate template fields, add context identifiers, supplement the prompt, and perform other normalization operations described herein. In other cases, the prompt hydrator 740 can be configured to segment a single prompt into multiple discrete requests, which may be interdependent or may be independent.

Thereafter, the modified prompt(s) can be provided as input to an output queue at 742 that may serve to meter inputs provided to the generative output engine 728.

These foregoing embodiments depicted in FIG. 7A-7B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

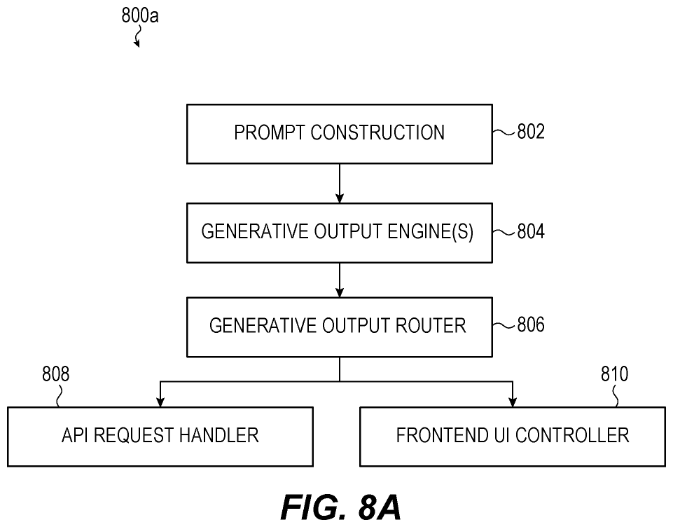

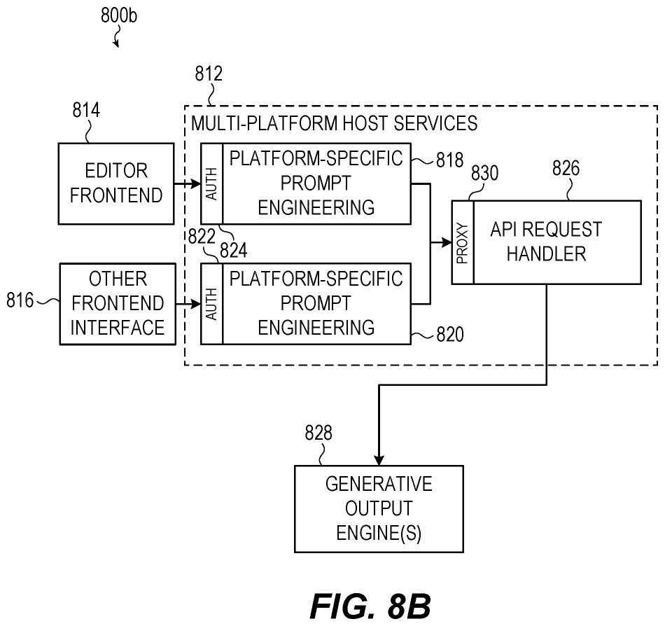

FIG. 8A depicts a simplified system diagram and data processing pipeline as described herein. The system 800a receives user input, and constructs a prompt therefrom at operation 802. After constructing a suitable prompt, and populating template fields, selecting appropriate instructions and examples for an LLM to continue, the modified constructed prompt is provided as input to a generative output engine 804. A continuation from the generative output engine 804 is provided as input to a router 806 configured to classify the output of the generative output engine 804 as being directed to one or more destinations. For example, the router 806 may determine that a particular generative output is an API request that should be executed against a particular API (e.g., such as an API of a system or platform as described herein). In this example, the router 806 may direct the output to an API request handler 808. In another example, the router 806 may determine that the generative output may be suitably directed to a graphical user interface/frontend 810.

Another example architecture is shown in FIG. 8B, illustrating a system providing prompt management, and in particular multiplatform prompt management as a service. The system 800b is instantiated over cloud resources, which may be provisioned from a pool of resources in one or more locations (e.g., datacenters). In the illustrated embodiment, the provisioned resources are identified as the multi-platform host services 812.

The multi-platform host services 812 can receive input from one or more users in a variety of ways. For example, some users may provide input via an editor region 814 of a frontend, such as described above. Other users may provide input by engaging with other user interface elements 816 unrelated to common or shared features across multiple platforms. Specifically, the second user may provide input to the multi-platform host services 812 by engaging with one or more platform-specific user interface elements. In yet further examples, one or more frontends or backends can be configured to automatically generate one or more prompts for continuation by generative output engines as described herein. More generally, in many cases, user input may not be required and prompts may be requested and/or engineered automatically.

Once a prompt has been engineered/supplemented by one of the platform-specific prompt engineering services 818, 820, it may be passed to a request queue/API request handler 826 configured to generate an API request directed to a generative output engine 830 including appropriate API tokens and the engineered prompt as a portion of the body of the API request. In some cases, a service proxy 830 can interpose the platform-specific prompt engineering services 818, 820 and the request queue/API request handler 826, so as to further modify or validate prompts prior to wrapping those prompts in an API call to the generative output engine 828 by the request queue/API request handler 826 although this is not required of all embodiments.

Another example architecture is shown in FIG. 8B, illustrating a system providing prompt management, and in particular multiplatform prompt management as a service. The system 800b is instantiated over cloud resources, which may be provisioned from a pool of resources in one or more locations (e.g., datacenters). In the illustrated embodiment, the provisioned resources are identified as the multi-platform host services 812.

The multi-platform host services 812 can receive input from one or more users in a variety of ways. For example, some users may provide input via an editor region 814 of a frontend, such as described above. Other users may provide input by engaging with other user interface elements 816 unrelated to common or shared features across multiple platforms. Specifically, the second user may provide input to the multi-platform host services 812 by engaging with one or more platform-specific user interface elements. In yet further examples, one or more frontends or backends can be configured to automatically generate one or more prompts for continuation by generative output engines as described herein. More generally, in many cases, user input may not be required and prompts may be requested and/or engineered automatically.

The multi-platform host services 812 can include multiple software instances or microservices each configured to receive user inputs and/or proposed prompts and configured to provide, as output, an engineered prompt. In many cases, these instances—shown in the figure as the platform-specific prompt engineering services 818, 820—can be configured to wrap proposed prompts within engineered prompts retrieved from a database such as described above.

In many cases, the platform-specific prompt engineering services 818, 820 can be each configured to authenticate requests received from various sources. In other cases, requests from editor regions or other user interface elements of particular frontends can be first received by one or more authenticator instances, such as the authentication instances 822, 824. In other cases, a single centralized authentication service can provide authentication as a service to each request before it is forwarded to the platform-specific prompt engineering services 818, 820.

Once a prompt has been engineered/supplemented by one of the platform-specific prompt engineering services 818, 820, it may be passed to a request queue/API request handler 826 configured to generate an API request directed to a generative output engine 830 including appropriate API tokens and the engineered prompt as a portion of the body of the API request. In some cases, a service proxy 830 can interpose the platform-specific prompt engineering services 818, 820 and the request queue/API request handler 826, so as to further modify or validate prompts prior to wrapping those prompts in an API call to the generative output engine 828 by the request queue/API request handler 826 although this is not required of all embodiments.

These foregoing embodiments depicted in FIG. 7A-8B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

More generally, it may be appreciated that a system as described herein can be used for a variety of purposes and functions to enhance functionality of collaboration tools. Detailed examples follow. Similarly, it may be appreciated that systems as described herein can be configured to operate in a number of ways, which may be implementation specific.

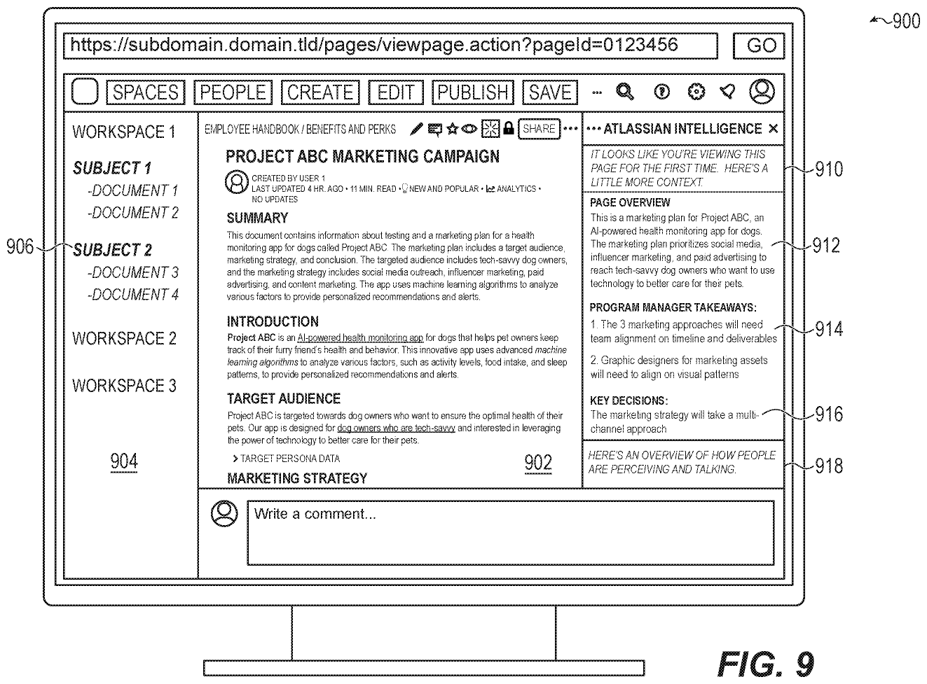

FIG. 9 depicts another example of use of a generative output engine with a collaboration platform. In the current example, the collaboration platform is a documentation platform with a frontend operating on a client device. The frontend of the documentation platform causes display of a graphical user interface 900 on the display of a client device. This particular graphical user interface 900 includes a multiple panel or multiple region graphical user interface, similar to the example described above with respect to FIG. 5. Similar to previous examples, the graphical user interface 900 includes a main panel 902, which may be operated as a content viewing or content reading panel and transitioned to a content editor panel. Also similar to previous examples, the graphical user interface includes a navigational panel 904 that includes selectable navigational elements. In particular, the navigational panel 904 includes a hierarchical navigational element tree 906 of elements in which each element is selectable to cause display of the respective content of a corresponding content item (electronic document or page) within the main panel 902. Similar to other examples described herein, the navigational panel 904 may include other navigational trees or elements that are selectable to cause display of respective content. The navigational panel 904 may also include other selectable elements that are selectable to cause navigation to other aspects of the system including, without limitation, calendars, blogs, analytics, user profiles, and other endpoints accessible by the graphical user interface 900.

In the example of FIG. 9, the graphical user interface 900 of FIG. 9 includes an additional region referred to herein as a summary region 910. The summary region 900 is positioned along the periphery of the graphical user interface 900 and, in this example, is positioned along a side of the main region 902 opposite to the navigational region 904. The summary region 910 includes multiple sub-regions or predefined areas that may include generative output provided by a generative output engine. In general, the summary region 910 includes content that is generated based on content displayed in the main panel 902 using content extracted from the electronic document or page being viewed or edited in the main panel 902.

In accordance with the techniques and examples provided herein, content may be extracted from the corresponding document or page content and may be used to generate one or more prompts. The one or more prompts may include predefined query prompt text that is selected in accordance with a content type of the particular page, a role of the user, or other context data associated with the current session. For example, the one or more prompts may include predefined query prompt text that is adapted for one or more of: a project content type, a knowledge base or knowledge base documentation content type, a user or product profile content type, a blog or journal content type, a meeting notes content type, a code summary or code documentation content type, or other content type. The content type of the particular or current page or document may be determined in advance and the content may include one or more tags or document metadata that indicates the content type. In other implementations, the content type may be determined based on a semantic analysis or other natural language processing analysis of the page or document content subsequent to the page or document being loaded into the graphical user interface for display. In some cases, the content type is based on pages or documents that are proximate to the current page or document in the hierarchical navigational tree of elements 906.

Similarly, the predefined query prompt text may be based on a user role or other aspect of the user profile. For example, the type of summary, tone of the summary, technical character of the summary may vary depending in accordance with a predicted use of the authenticated user. Specifically, an authenticated user having a role that is more technical (e.g., engineer or software developer) may be provided with content that is more technical or detailed as compared to an authenticated user having a role that is less technical. In this way, the content of the summary region 910 may change in accordance with the authenticated user accessing the page or document. Similarly, the predefined query prompt text may also vary in accordance with other context data including, for example, other applications being concurrently used, user view history of user event logs from a current or recent session, other content or objects being concurrently viewed or edited or having been viewed or edited in a recent session. For example, the system may detect a concurrent use of a messaging platform or issue tracking platform indicating that the current user is providing assistance in accordance with an information technology system management (ITSM) role or session. As a result, the predefined query prompt text may be selected in order to extract steps or a procedure outline from the currently viewed content. When the same user views the current page or document during another session (not associated with an ITSM role or session), the predefined query prompt may be selected in order to provide a more general content summary or other information to the user. Thus, the content, e.g., 912, 914, 916, and 918, provided in the summary region 910 may vary for a particular user in accordance with a change in context data.

A prompt, including the predefined query prompt text and content extracted from the current page or document, may be provided to a generative output engine. The generative output engine may produce a generative output or generative response, which is used to generate or render the content in the summary panel 910. In one example implementation, the summary panel includes multiple generative content that may be generated in response to a single composite prompt or in response to multiple prompts that are provided to the generative output engine. In the example of FIG. 9, the summary panel 910 includes a content summary that is based on content extracted from the current page or document. In some cases, the content summary includes content that is extracted from pages or documents that are proximate to the current page or document in the hierarchical navigational tree of elements 906. In some cases, the content summary also includes content that was extracted from pages associated with the current user or with a project associated with the current user. In the summary panel 910 of FIG. 9, the generative response may also include a list of task summary items generated by the generative output engine using the page or document content and predefined query prompt text. As described herein, the predefined query prompt text may be formulated to cause the generative output engine to identify action items or task summaries in a portion of provided content.

The summary panel 910 may also include link objects or other selectable objects that correspond to other content items that are related to the current page or document. In some cases, one or more additional prompts are provided to the generative output engine, which is used to provide summaries, brief titles, or other generative content based on content extracted from each respective linked content item. The summary panel 910 may include other content including related user accounts, related projects, or other information derived from the currently displayed content and/or the current user session.

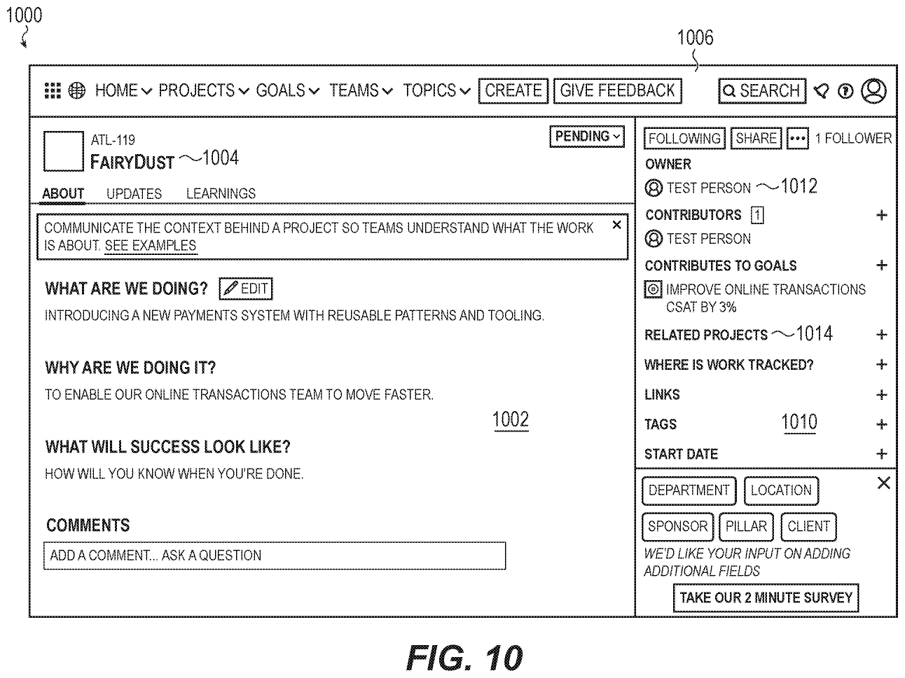

FIG. 10 depicts an example directory platform having a graphical user interface 1000 including a home page for an entry associated with the selected word “FairyDust” as indicated by the title or label 1004. In response to user selection of the corresponding word 1506, the system may access the entry 1002 depicted in the graphical user interface 1000 of FIG. 10, and extract content from the entry 1002 and use the extracted content to generate a prompt to be transmitted to the generative output engine. In some implementations, content from the description in the entry and other descriptive text may be extracted and used to generate the prompt. Other information that may be used to generate the prompt include user accounts or related users 1012, content from related projects 1014 or other information that may be associated with the entry 1002, as indicated in the region 1010 of the example graphical user interface 1000.

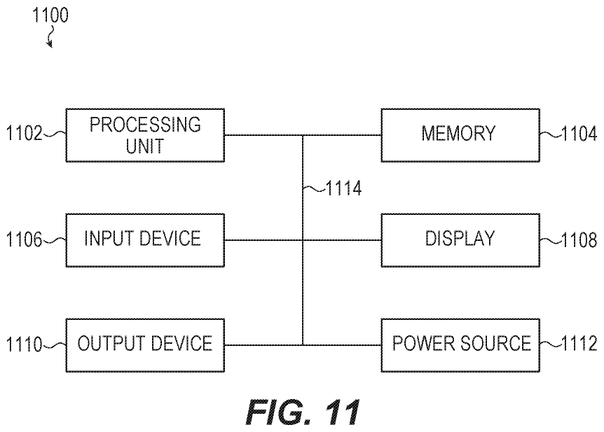

FIG. 11 shows a sample electrical block diagram of an electronic device 1100 that may perform the operations described herein. The electronic device 1100 may in some cases take the form of any of the electronic devices described with reference to FIGS. 1, including client devices, and/or servers or other computing devices associated with the collaboration system 100. The electronic device 1100 can include one or more of a processing unit 1102, a memory 1104 or storage device, input devices 1106, a display 1108, output devices 1110, and a power source 1112. In some cases, various implementations of the electronic device 1100 may lack some or all of these components and/or include additional or alternative components.

The processing unit 1102 can control some or all of the operations of the electronic device 1100. The processing unit 1102 can communicate, either directly or indirectly, with some or all of the components of the electronic device 1100. For example, a system bus or other communication mechanism 1114 can provide communication between the processing unit 1102, the power source 1112, the memory 1104, the input device(s) 1106, and the output device(s) 1110.

The processing unit 1102 can be implemented as any electronic device capable of processing, receiving, or transmitting data or instructions. For example, the processing unit 1102 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1100 can be controlled by multiple processing units. For example, select components of the electronic device 1100 (e.g., an input device 1106) may be controlled by a first processing unit and other components of the electronic device 1100 (e.g., the display 1108) may be controlled by a second processing unit, where the first and second processing units may or may not be in communication with each other.

The power source 1112 can be implemented with any device capable of providing energy to the electronic device 1100. For example, the power source 1112 may be one or more batteries or rechargeable batteries. Additionally, or alternatively, the power source 1112 can be a power connector or power cord that connects the electronic device 1100 to another power source, such as a wall outlet.

The memory 1104 can store electronic data that can be used by the electronic device 1100. For example, the memory 1104 can store electronic data or content such as, for example, audio and video files, documents and applications, device settings and user preferences, timing signals, control signals, and data structures or databases. The memory 1104 can be configured as any type of memory. By way of example only, the memory 1104 can be implemented as random access memory, read-only memory, flash memory, removable memory, other types of storage elements, or combinations of such devices.

In various embodiments, the display 1108 provides a graphical output, for example associated with an operating system, user interface, and/or applications of the electronic device 1100 (e.g., a chat user interface, an issue-tracking user interface, an issue-discovery user interface, etc.). In one embodiment, the display 1108 includes one or more sensors and is configured as a touch-sensitive (e.g., single-touch, multi-touch) and/or force-sensitive display to receive inputs from a user. For example, the display 1108 may be integrated with a touch sensor (e.g., a capacitive touch sensor) and/or a force sensor to provide a touch- and/or force-sensitive display. The display 1108 is operably coupled to the processing unit 1102 of the electronic device 1100.

The display 1108 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 1108 is positioned beneath and viewable through a cover that forms at least a portion of an enclosure of the electronic device 1100.

In various embodiments, the input devices 1106 may include any suitable components for detecting inputs. Examples of input devices 1106 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 1106 may be configured to detect one or more particular types of input and provide a signal (e.g., an input signal) corresponding to the detected input. The signal may be provided, for example, to the processing unit 1102.

As discussed above, in some cases, the input device(s) 1106 include a touch sensor (e.g., a capacitive touch sensor) integrated with the display 1108 to provide a touch-sensitive display. Similarly, in some cases, the input device(s) 1106 include a force sensor (e.g., a capacitive force sensor) integrated with the display 1108 to provide a force-sensitive display.

The output devices 1110 may include any suitable components for providing outputs. Examples of output devices 1110 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device 1110 may be configured to receive one or more signals (e.g., an output signal provided by the processing unit 1102) and provide an output corresponding to the signal.

In some cases, input devices 1106 and output devices 1110 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1102 may be operably coupled to the input devices 1106 and the output devices 1110. The processing unit 1102 may be adapted to exchange signals with the input devices 1106 and the output devices 1110. For example, the processing unit 1102 may receive an input signal from an input device 1106 that corresponds to an input detected by the input device 1106. The processing unit 1102 may interpret the received input signal to determine whether to provide and/or change one or more outputs in response to the input signal. The processing unit 1102 may then send an output signal to one or more of the output devices 1110, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

What is claimed is:

1. A method for generating a set of child issues based on a parent issue, the method comprising:
cause display of the parent issue in a graphical user interface of an issue tracking system;
in response to a user input provided to the graphical user interface, the user input including a request for a set of subtasks based on the parent issue, identify a resource identifier using content extracted from the parent issue;
access a first node of a content graph using the resource identifier;
identify a first set of nodes having an edge with the first node in the content graph;
generate a prompt comprising:
a predefined query prompt text including a request to rank nodes and a completion criterion; and
content extracted from the first set of nodes;
provide the prompt to an external generative output engine using an application programming interface call;
obtain a generative response from the external generative output engine;
in response to the generative response indicating that the completion criterion has not been satisfied, identify a next node of the first set of nodes using the generative response and identify a second set of nodes having an edge with the next node;
in response to the generative response indicating that the completion criterion has been satisfied, generate a set of suggested subtasks using the generative response;
cause display in the graphical user interface of the set of suggested subtasks; and
in response to an additional user input, cause a set of new child issues to be generated in the issue tracking system, each respective child issue of the set of new child issues corresponding to a respective task of the set of suggested subtasks.

2. The method of claim 1, wherein the prompt is a first prompt and further comprising:
in accordance with the completion criterion not being satisfied, generate a second prompt comprising:
the predefined query prompt text including the request to rank nodes and the completion criterion; and
content extracted from the second set of nodes;
obtain an updated generative response from the external generative output engine;
in response to the updated generative response indicating that the completion criterion has been satisfied, generate the set of suggested subtasks using the updated generative response; and
cause display in the graphical user interface of the set of suggested subtasks.

3. The method of claim 1, further comprising:
in accordance with identifying the first set of nodes, evaluate permissions with respect to a current user providing the user input;
in response to the current user satisfying a permissions criterion, query a database to obtain content from each node of the first set of nodes, the content of each node corresponding to a respective platform; and
hydrating the prompt to include the queried content.

4. The method of claim 3, wherein the prompt further comprises a request to select a top ranking from the first set of nodes.

5. The method of claim 1, wherein the content graph is generated using content from an issue tracking platform, a content collaboration platform, a project management platform, and an external platform.

6. The method of claim 1, wherein each suggested subtask of the set of suggested subtasks includes a reference to an existing issue or an existing document.

7. The method of claim 1, wherein the prompt further comprises metadata comprising an issue type corresponding to each node of the first set of nodes.

8. A method for automatically generating subtasks in an issue tracking platform based on a parent issue and context extracted from a plurality of platforms, the method comprising:
receiving a user input comprising the parent task of the task and a request to create a list of subtasks based on the parent task of the task;
in response to the request to create the list of subtasks, retrieving a first resource identifier based on data from the task;
querying a content graph using the first resource identifier to obtain a second resource identifier, the second resource identifier having an edge relationship with respect to the first resource identifier, the content graph generated from content from at least two of the issue tracking platform, a content collaboration platform, or a project management platform;
generating a first prompt including the parent task, content from the first resource identifier, content from the second resource identifier, and predefined content having a completion criterion;
submitting the first prompt to an external generative output engine using an application programming interface call;
obtaining a first generative response from the external generative output engine;
in response to the first generative response indicating that the completion criterion has not been satisfied, querying the content graph using the second resource identifier to obtain a third resource identifier, the second resource identifier having an edge relationship with respect to the first resource identifier;
generating a second prompt including at least a portion of the content from the first prompt and content from the third resource identifier;
in response to receiving a second generative response from the external generative output engine indicating that the completion criterion has been satisfied, analyzing the second generative response to identify a suggested subtask; and
causing display, in a graphical user interface, of the suggested subtask, the suggested subtask including a reference to a particular document or issue.

9. The method of claim 8, wherein:
the second resource identifier is a plurality of second resource identifiers, each second resource identifier representing a respective node in the content graph; and
the first prompt further comprises a request to rank the plurality of second resource identifiers.

10. The method of claim 9, wherein:
the first prompt further comprises a filter criterion; and
in response to receiving the first prompt comprising content from the plurality of second resource identifiers, selecting a sub-plurality of second resource identifiers satisfying the filter criterion.

11. The method of claim 8, further comprising:
causing a child issue to be generated in the issue tracking platform, the generated child issue corresponding to the suggested subtask.

12. The method of claim 11, wherein the child issue is associated with an issue corresponding to the first resource identifier.

13. The method of claim 11, further comprising:
updating the content graph to include the generated child issue.

14. The method of claim 8, further comprising:
in accordance with identifying the second resource identifier, evaluating permissions with respect to a current user providing the user input;
in response to the current user satisfying a permissions criterion, querying a database to obtain content corresponding to the second resource identifier, the second resource identifier associated with the content collaboration platform; and
hydrating the first prompt to include the queried content.

15. A method for generating a set of child issues based on a parent issue using generative tools, the method comprising:
causing display of the parent issue in a graphical user interface of an issue tracking system;
in response to a textual input provided to the graphical user interface, the textual input including at least a reference to the parent issue;
receiving a request to create a set of subtasks based on the parent issue;
identifying a resource identifier based on data from the parent issue;
accessing a first node of a content graph corresponding to the resource identifier;
identifying, using the content graph, at least one related node having an edge with respect to the first node;
obtaining content corresponding to the at least one related node from a respective platform;
generating a prompt comprising:
a predefined query prompt text including a completion criterion; and
content obtained from the at least one related node;
sending the prompt to an external generative output engine;
obtaining a generative response from the external generative output engine including an indication that the completion criterion is not satisfied;
obtaining subsequent nodes from the content graph based on a prior node;
iteratively sending subsequent prompts using content obtained from the subsequent nodes, until a subsequent generative response indicates satisfaction of the completion criterion;
in response to satisfying the completion criterion, generate a set of suggested subtasks using the subsequent generative response; and
cause display in the graphical user interface of the set of suggested subtasks.

16. The method of claim 15, further comprising:
in accordance with identifying the at least one related node and the subsequent nodes, evaluating permissions with respect to a current user;
in response to the current user satisfying a permissions criterion, querying a database to obtain content from each node of the at least one related node and the subsequent nodes, the content of each node corresponding to a respective platform; and
hydrating each subsequent prompt to include the queried content.

17. The method of claim 15, wherein the content graph is generated using data from an issue tracking platform, a content collaboration platform, a software management platform, and a software development platform.

18. The method of claim 15, wherein a first node of the at least one related node is a pull request.

19. The method of claim 15, wherein the external generative output engine is a large language model.

20. The method of claim 19, wherein a branch of nodes is excluded from a subtask generation based on a relationship between a parent node and a first subsequent node.
